(19) United States
(12) Patent Application Publication
(10) Pub. No.: US 2005/0278708 A1
(43) Pub. Date: Dec. 15, 2005

(54) Event management framework for network management application development

(76) Inventors: Dong Zhao, Lisle, IL (US); Edward G. Brunell, Chicago, IL (US); Kwok-Chien Choy, Wayne, NJ (US); Shankar Krishnamoorthy, Scotch Plains, NJ (US); Manjula Sridhar, Lisle, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/868,250

(22) Filed: Jun. 15, 2004

(51) Int. Cl. G06F 9/45

(52) U.S. Cl. 717/136; 717/143; 717/110; 717/106

(57) ABSTRACT

Methods of developing an application program to manage a distributed system or network are provided. In one embodiment, the method includes: a) defining managed objects in a resource definition language and storing the definition in resource definition language files, b) parsing the resource definition language files to ensure conformity with the resource definition language and creating an intermediate representation of the distributed system, c) processing the intermediate representation to form programming language classes, database definition files, and script files, d) developing a reusable asset center framework to facilitate development of the application program, the reusable asset center including an event management framework that provides an event processing model for defining, routing, and processing events associated with the distributed system or network, and e) building the application program from the programming language classes, database definition files, script files, and the reusable asset framework.

### CROSS-REFERENCE TO RELATED APPLICATIONS

This application is related to Zhao et al., Attorney Docket No. LUTZ 2 00268 and Lucent Case Name/No. Brunell 1-1-1-1-1, entitled “Run-Time Tool for Network Management Application,” filed Jun. 15, 2004, commonly assigned to Lucent Technologies, Inc. and incorporated by reference herein.

This application is related to Sridner et al., Attorney Docket No. LUTZ 2 00289 and Lucent Case Name/No. Brunell 2-2-2-2-2, entitled “Resource Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00324 and Lucent Case Name/No. Brunell 3-3-3-3-3, entitled “View Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00323 and Lucent Case Name/No. Brunell 4-1-4-4-4-4, entitled “Distribution Adaptor for Network Management Application Development,” filed Jun. 15, 2004, commonly assigned to Lucent Technologies, Inc. and incorporated by reference herein.

This application is related to Sridner et al., Attorney Docket No. LUTZ 2 00326 and Lucent Case Name/No. Brunell 6-1-6-5-6-6, entitled “Managed Object Framework for Network Management Application Development,” filed Jun. 15, 2004, commonly assigned to Lucent Technologies, Inc. and incorporated by reference herein.

This application is related to Shen et al., Attorney Docket No. LUTZ 2 00327 and Lucent Case Name/No. Brunell 7-7-6-7-7, entitled “Data Management and Persistence Frameworks for Network Management Application Development,” filed Jun. 15, 2004, commonly assigned to Lucent Technologies, Inc. and incorporated by reference herein.

This application is related to Sridner et al., Attorney Docket No. LUTZ 2 00328 and Lucent Case Name/No. Brunell 8-2-8-1-8-8, entitled “SNMP Agent Code Generation and SNMP Agent Framework for Network Management Application Development,” filed Jun. 15, 2004, commonly assigned to Lucent Technologies, Inc. and incorporated by reference herein.

### BACKGROUND OF THE INVENTION

The invention generally relates to a reusable asset center (RAC) framework in a development environment for network management applications and, more particularly, to an event management framework (EMF) within the RAC framework for providing the network management applications with event message routing and broadcasting.

While the invention is particularly directed to the art of network management application development, and will be thus described with specific reference thereto, it will be appreciated that the invention may have usefulness in other fields and applications.

By way of background, Guidelines for Definition of Managed Objects (GDMO) and Structure for Management Information (SMI) are existing standards for defining objects in a network. Managed objects that are defined can be accessed via a network management protocol, such as the existing Simple Network Management Protocol (SNMP). Various standards, recommendations, and guidelines associated with GDMO, SMI, and SNMP have been published. GDMO is specified in ISO/IEC Standard 10165/x.722. Version 1 of SMI (SMIv1) is specified in Network Working Group (NWG) Standard 16 and includes Request for Comments (RFCs) 1155 and 1212. Version 2 of SMI (SMIv2) is specified in NWG Standard 58 and includes RFCs 2578 through 2580. The latest version of SNMP (SNMPv3) is specified in NWG Standard 62 and includes RFCs 3411 through 3418.

ISO/IEC Standard 10165/x.722, GDMO, identifies: a) relationships between relevant open systems interconnection (OSI) management Recommendations/International Standards and the definition of managed object classes, and how those Recommendations/International Standards should be used by managed object class definitions; b) appropriate methods to be adopted for the definition of managed object classes and their attributes, notifications, actions and behavior, including: 1) a summary of aspects that shall be addressed in the definition; 2) the notational tools that are recommended to be used in the definition; 3) consistency guidelines that the definition may follow; c) relationship of managed object class' definitions to management protocol, and what protocol-related definitions are required; and d) recommended documentation structure for managed object class definitions. X.722 is applicable to the development of any Recommendation/International Standard which defines a) management information which is to be transferred or manipulated by means of OSI management protocol and b) the managed objects to which that information relates.

RFC 1155, Structure and Identification of Management Information for TCP/IP-based Internets, describes the common structures and identification scheme for the definition of management information used in managing TCP/IP-based internets. Included are descriptions of an object information model for network management along with a set of generic types used to describe management information. Formal descriptions of the structure are given using Abstract Syntax Notation One (ASN.1).

RFC 1212, Concise Management Information Base (MIB) Definitions, describes a straight-forward approach toward producing concise, yet descriptive, MIB modules. It is intended that all future MIB modules be written in this format. The Internet-standard SMI employs a two-level approach towards object definition. An MIB definition consists of two parts: a textual part, in which objects are placed into groups, and an MIB module, in which objects are described solely in terms of the ASN.1 macro OBJECT-TYPE, which is defined by the SMI.

Management information is viewed as a collection of managed objects, residing in a virtual information store, termed the MIB. Collections of related objects are defined in MIB modules. These modules are written using an adapted subset of OSI's ASN.1. RFC 2578, SMI Version 2 (SMIv2), defines that adapted subset and assigns a set of associated administrative values.

The SMI defined in RFC 2578 is divided into three parts: module definitions, object definitions, and, notification definitions. Module definitions are used when describing information modules. An ASN.1 macro, MODULE-IDENTITY, is used to concisely convey the semantics of an information module. Object definitions are used when describing managed objects. An ASN.1 macro, OBJECT-TYPE, is used to concisely convey the syntax and semantics of a managed object. Notification definitions are used when describing unsolicited transmissions of management information. An ASN.1 macro, NOTIFICATION-TYPE, is used to concisely convey the syntax and semantics of a notification.

RFC 2579, Textual Conventions for SMIv2, defines an initial set of textual conventions available to all MIB modules. Management information is viewed as a collection of managed objects, residing in a virtual information store, termed the MIB. Collections of related objects are defined in MIB modules. These modules are written using an adapted subset of OSI's ASN.1, termed the SMI defined in RFC 2578. When designing an MIB module, it is often useful to define new types similar to those defined in the SMI. In comparison to a type defined in the SMI, each of these new types has a different name, a similar syntax, but a more precise semantics. These newly defined types are termed textual conventions, and are used for the convenience of humans reading the MIB module. Objects defined using a textual convention are always encoded by means of the rules that define their primitive type. However, textual conventions often have special semantics associated with them. As such, an ASN.1 macro, TEXTUAL-CONVENTION, is used to concisely convey the syntax and semantics of a textual convention.

RFC 2580, Conformance Statements for SMIv2, defines the notation used to define the acceptable lower-bounds of implementation, along with the actual level of implementation achieved, for management information associated with the managed objects.

Network elements need a way to define managed resources and access/manage those resources in a consistent and transparent way. GDMO does not provide a straight forward approach to defining resources. SMI does not provide for an object-oriented design of network management applications. Neither standard provides sufficient complexity of hierarchy or sufficient complexity of control for management of today's complex networks, particular today's telecommunication networks.

The present invention contemplates an EMF within a RAC framework of a development environment for network management applications that resolves the above-referenced difficulties and others.

### SUMMARY OF THE INVENTION

A method of developing one or more application programs that cooperate to manage a distributed system comprising one or more servers is provided. At least one application program is associated with each server. In one aspect, the method includes: a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system, b) parsing the one or more resource definition language files to ensure conformity with the object-oriented resource definition language and creating an intermediate representation of the distributed system from the one or more conforming resource definition language files, c) processing the intermediate representation of the distributed system to form one or more programming language classes, one or more database definition files, and one or more script files, d) providing a reusable asset center framework to facilitate development of the one or more application programs, the reusable asset center including an event management framework that provides an event processing model for defining, routing, and processing events associated with the distributed system, and e) building the one or more application programs from at least the one or more programming language classes, one or more database definition files, one or more script files, and the reusable asset framework.

A method of developing one or more application programs in operative communication to manage a network including one or more servers is provided. At least one application program is associated with each server. In one aspect, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network created in the parsing step includes a parse tree, c) processing the parse tree to form one or more programming language classes, wherein the one or more programming language classes formed include at least one of one or more system classes, one or more module classes, one or more managed object classes, and one or more composite attribute classes, d) providing a reusable asset center framework to facilitate development of the one or more application programs, the reusable asset center including an event management framework that provides an event processing model for defining, routing, and processing events associated with selected managed objects of the network, and e) building the one or more application programs from at least the one or more programming language classes and the reusable asset framework.

A method of developing an application program to manage a network is provided. In one aspect, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network includes object meta-data, c) processing the object meta-data to form one or more programming language classes, one or more database definition files, and one or more script files, wherein the one or more programming language classes formed include at least one of an index class and a query class, d) providing a reusable asset center framework to facilitate development of the application program, the reusable asset center including an event management framework that provides an event processing model for defining, routing, and processing events associated with the network, and e) building the application program from at least the one or more programming language classes, one or more database definition files, one or more script files, and the reusable asset framework.

Benefits and advantages of the invention will become apparent to those of ordinary skill in the art upon reading and understanding the description of the invention provided herein.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an embodiment of a reusable asset center (RAC) development environment for development of network management applications.

FIG. 2 is a block diagram of an embodiment of a run-time network management environment with network management applications developed by the RAC development environment.

FIG. 3 is a block diagram of an embodiment of a resource definition language file(s) block of the RAC development environment.

FIG. 4 is a block diagram of an embodiment of a parser(s) block of the RAC development environment.

FIG. 5 is a block diagram of an embodiment of an options block of the RAC development environment.

FIG. 6 is a block diagram of an embodiment of a code generator(s) block of the RAC development environment.

FIG. 7 is a block diagram of an embodiment of a RAC management framework block of the RAC development environment.

FIG. 8 is a block diagram of an embodiment of a run-time tool(s) block of the RAC development environment.

FIG. 9 is a block diagram of an embodiment of a RAC development environment for generating event management framework (EMF) objects.

FIG. 10 shows a layered communication architecture associated with the EMF and distribution adaptor (DA) in network management applications developed using the RAC development environment.

FIG. 11 is a block diagram of an exemplary architecture for the EMF.

FIG. 12 is a diagram of an exemplary message flow for the EMF.

FIG. 13 is a block diagram of an embodiment of the EMF.

FIG. 14 is a block diagram of an embodiment of event server classes of the EMF.

FIG. 15 is a block diagram of an embodiment of global resource identifier (GRID) classes of the event server classes.

FIG. 16 is a block diagram of an embodiment of event state classes of the EMF.

FIG. 17 is a block diagram of an embodiment of event handler classes of the EMF.

FIG. 18 is a block diagram of an embodiment of event handler proxy classes of the event handler classes.

### DETAILED DESCRIPTION OF THE PREFERRED EMBODIMENTS

Referring now to the drawings wherein the showings are for purposes of illustrating the preferred embodiments of the invention only and not for purposes of limiting same.

In general, a reusable asset center (RAC) development environment for network management application development is provided. RAC, as used herein, generically refers to a reusable set of frameworks for network management application development. The set of frameworks is referred to as the RAC management framework. Network, as used herein, generically refers to a system having a set of resources arranged in a distributed architecture. For example, the RAC development environment may be used to develop network management applications for a TCP/IP-based network or any other type of communication network. For example, the RAC development environment may be used to develop network management applications for landline and/or wireless telecommunication networks. Likewise, the RAC development environment may be used to develop management applications for any type of system having a distributed architecture. Defined as such, the RAC framework is inherently reusable in other networks (i.e., systems). Moreover, major portions of code used to build management applications in the RAC development environment are inherently reusable.

The RAC development environment includes a Managed Object Definition Language (MODL) to specify managed objects in a network or system design and management information associated with the managed objects. The syntax for MODL is object-oriented and the semantics are similar to GDMO. This provides a simplified language for defining data models and acts as a single point translation mechanism to support interacting with different schema types. In essence, MODL provides a protocol-independent mechanism for accessing management information for managed objects within the network design. MODL can be used to define data models describing the managed resources of the network design in terms of managed resources having managed objects, define data types (attributes) representing various resources and objects, and define relationships among the managed resources and objects.

MODL allows network management applications to specify the resources to be managed in a given network design. The RAC development environment also includes MODL code generation from MODL files defining the managed objects and information. This provides automatically generated code to access these resources. Network management application developers can choose to make these resources persistent or transient. Developers can choose among various options to customize the code generation to suit the needs of the operators/maintainers (i.e., providers) of the network. MODL is object-oriented and allows applications to capture complex resources in a systematic way.

The RAC management framework provides an operation, administration, and maintenance (OAM) management framework catering to common OAM needs of the network and its managed resources and objects. The services offered by the RAC management framework range from standard system management functions to generic functions, such as event management, SNMP proxy interface, persistency services, and view management. These services are offered in a protocol-independent and operating system-independent manner.

Most of the common OAM needs of network elements are described in the ITU-T specifications X-730 through X-739 and are known as system management functions. The process leading to development of a RAC management framework provides for systematic and consistent reuse of code. In addition to requirements prescribed by applicable standards, the RAC management framework also provides, for example, functionalities such as persistence, view management and SNMP interface capabilities.

The following requirements of ITU-T X.730 (ISO/IEC 10164-1: 1993(E)) associated with Object Management Function (OMF) services are fully supported in the RAC management framework: 1) creation and deletion of managed objects; 2) performing actions upon managed objects; 3) attribute changing; 4) attribute reading; and 5) event reporting. The RAC management framework also provides, for example, ITU-T X.731-like state management functionality through effective use of callbacks and event reporting.

The RAC management framework provides, for example, a minimal subset of attributes for representing relations as described in ITU-T X.732 (ISO/IEC 10164-3). Certain attributes in the RAC management framework provide, for example, ways to define and create parent and child relationships between managed resources. This enables developers to specify hierarchical structures in the data model representing the network design.

The RAC management framework includes a standalone event management framework to implement event-handling services as described by ITU-T X.734 (ISO/IEC 10164-5). Regarding event-handling services, the RAC management framework, for example, permits: 1) definition of a flexible event report control service that allows systems to select which event reports are to be sent to a particular managing system, 2) specification of destinations (e.g. the identities of managing systems) to which event reports are to be sent, and 3) specification of a mechanism to control the forwarding of event reports, for example, by suspending and resuming the forwarding.

In addition to standard services, the RAC management framework provides additional capabilities associated with the functionality of various potential network elements. The RAC management framework also provides facilities to maintain data integrity in terms of default values and range checks and persistency of managed resources. For example, managed objects can be made persistent and all the OMF services are supported on these persistent managed objects. The managed objects can be manipulated from the back-end using standard Java database connectivity (JDBC) interfaces and synchronization is maintained so as to retain data integrity. This enables developers to manipulate data from multiple interfaces.

The RAC management framework provides a concept of views and view management services. Many network management applications, especially client applications, do not want to access or store the information about all the objects in the data model. The concept of views in the RAC management framework allows developers to create network management applications with access to a subset of the data model. Network management application developers can specify a view using a View Definition Language (VDL) that is included in the RAC development environment. View management services can be used to manage a cross-section of managed objects and associated resources in a single unit called a View. Most of the OMF services are also provided through the views.

The RAC management framework allows transparent distribution of the network management application. This decouples the network management application from changes in platforms and middleware environments. The network management application can be deployed in agent clients and agent servers servicing operation and maintenance centers (OMCs) (i.e., managers). The interface to the OMC can be Common Object Request Broker Architecture (CORBA), SNMP, JDBC, or another standard communication protocol for network management. For example, by simple inheritance, the agent server interface to the OMC can be extended to support other network management protocols, such as common management information protocol (CMIP), extensible markup language (XML), etc.

One of the key advantages for developers is that the RAC development environment automates development of portions of code with respect to the overall network management application. The RAC development environment generates the code based on the data model defined in MODL. The objects in the model get translated into subclasses in MODL code and access to the objects is generated using a build process in the RAC development environment. If the data model changes, corresponding MODL files can be revised and corresponding MODL code can be re-generated. Thus, streamlining change management of the network management application. The revised network management application is provided in a consistent and controlled manner through the object-oriented programming characteristics of MODL and the RAC management framework.

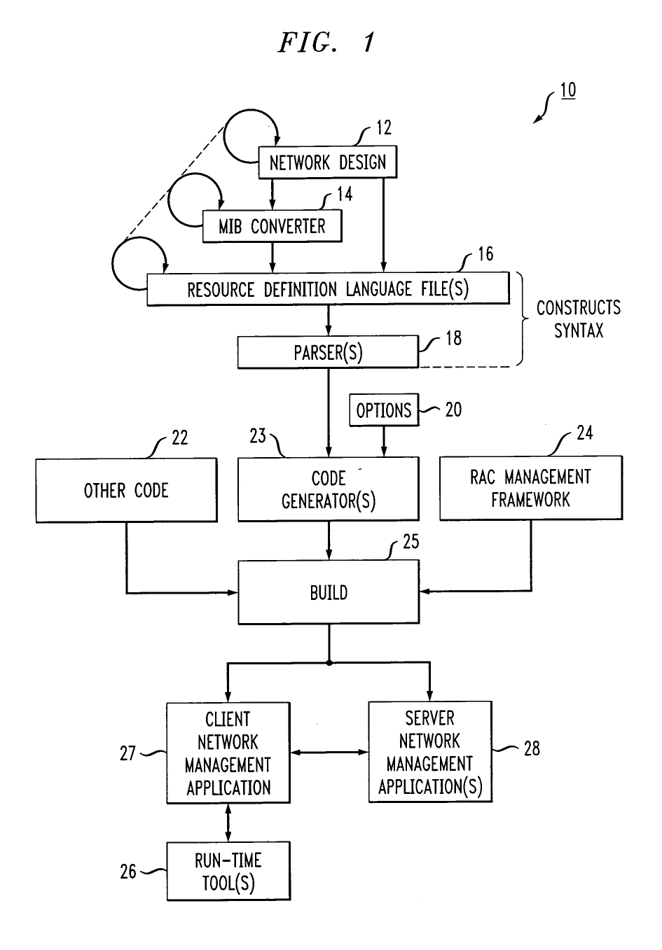

With reference to FIG. 1, a RAC development environment 10 includes a network design 12, an MIB converter 14, a resource definition language file(s) block 16, a parser(s) block 18, an options block 20, an other code block 22, a code generator(s) block 23, a RAC management framework block 24, a build process 25, a run-time tool(s) block 26, a client network management application 27, and a server network management application(s) 28. The RAC development environment 10 also includes computer hardware for storing and/or operating the various software development processes shown in FIG. 1. The computer hardware used in conjunction with the RAC development environment 10 may range from a network with multiple platforms to a stand-alone computer platform. The various processes for software development described herein may operate on any suitable arrangement of various types of computer equipment with various types of operating systems and various types of communication protocols. Thus, it is to be understood that the software development processes described herein do not require any specialized or unique computer architecture for the RAC development environment 10. The RAC development environment 10 represents an exemplary development cycle used by developers when preparing network management applications. Typically, developers begin with a design or data model for a network or system. This is depicted by the network design 12 and may include any design documentation describing the network and its resources or elements that is useful to the developers (i.e., data model). The network design 12 may include an existing MIB for one or more network resources.

If the network design 12 includes one or more MIBs, the MIB converter 14 converts the information in the MIBs to resource definition language file(s) 16. The developers use the network design 12 as source data for representing the remaining network resources and objects to be managed in the resource definition language file(s) block 16. The developers may also use the network design 12 to integrate the file(s) created by the MIB converter 14 with the other file(s) in the resource definition language file(s) block 18. Thus, the resource definition language file(s) block 16 includes one or more files defining the resources and objects within constructs and in appropriate syntax for one or more resource definition languages associated with the RAC development environment 10. Additional files may be included in the resource definition language file(s) block 18 defining one or more views of the resources and/or objects.

Files from the resource definition language file(s) block 18 are provided to an appropriate parser in the parser(s) block 18 to check for construct and syntax compliance and to build a parse tree. The parse tree is provided to the code generator(s) block 23. The options block 20 specifies certain options related to code generation by the code generator(s) block 23. The code generation options are customized by the developers based on the network design, parse tree, developer preferences, and/or network management application customer/user preferences.

The code generator(s) block 23 generates code for each managed resource and object defined in the resource definition language file(s) 16. The generated code provides various hooks and callbacks, which can be used by the developers to customize the flow of operations and behavior of the network management applications. The generated code primarily includes extensions of RAC management framework classes and eases the burden of coding and maintaining repeated functionality. The RAC management framework block 24 includes code organized in a group of subordinate frameworks. The RAC management framework 24 is implemented as a set of interrelated patterns (i.e., frameworks) that provide common functionality which can be selectively associated with the managed resources/objects and included in the generated code. The other code block 22 includes, for example, user-specific code and main methods which perform the initialization to get the final network management application.

The generated code from the code generator(s) block 23 is compiled and linked with code from the other code block 22 and the RAC management framework block 24 in the build process 25 to create a client network management application 27 and one or more server network management applications 28. At any stage in the application development, developers can add, delete or modify the managed resources/objects in the resource definition language files, re-generate the resource definition language code with new and/or revised managed resources/objects, and re-build the network management applications.

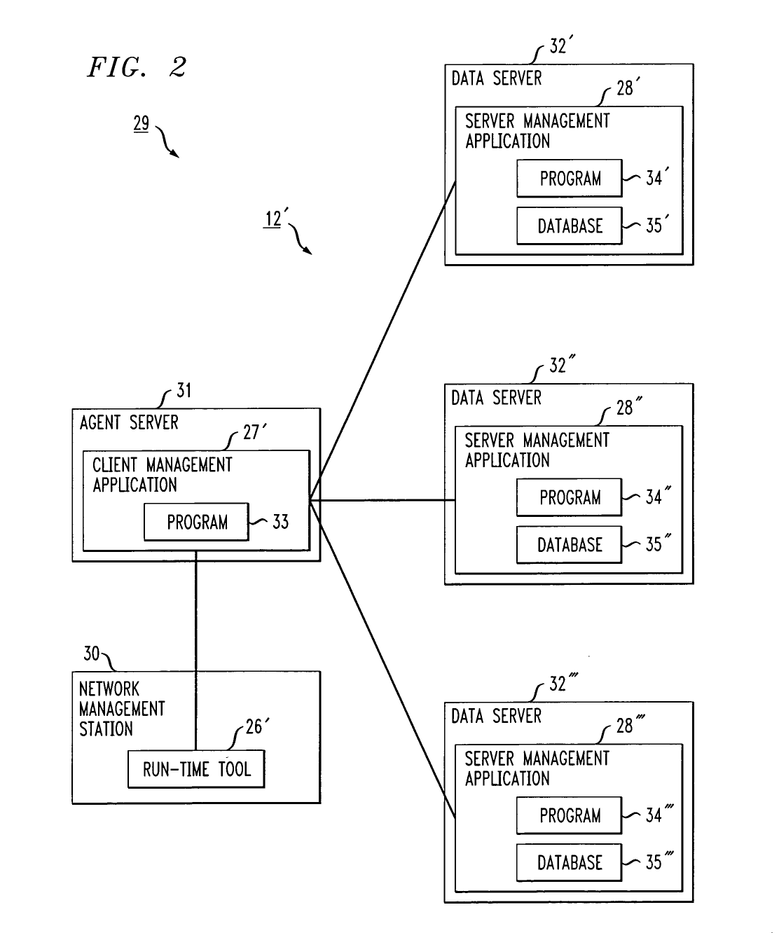

With reference to FIG. 2, an embodiment of a run-time network management environment 29 includes a network design 12′ to be managed in communication with a network management station 30. The network design includes an agent server 31 in communication with a first data server 32′, a second data server 32″, and a third data server 32′″. The network management station 30 includes an embodiment of the run-time tool 26′. The agent server 31 includes an embodiment of the client network management application 27′. The data servers 32′, 32″, 32′″ each include a corresponding embodiment of the server network management application 28′, 28″, 28′″. The client network management application 27′ includes an application program 33. Each server network management application 28′, 28″, 28′″ includes a corresponding application program 34′, 34″, 34′″ and management database 35′, 35″, 35′″.

Each of the data servers 32′, 32″, 32′″ includes one or more objects to be managed. For example, if any two network resources 32 are the same and the objects to be managed for both resources are also the same, the corresponding server network management application 28 may be the same on both resources. Otherwise, the application programs 34 and management databases 35 in the client network management applications are different based on the type of resource and/or type of objects to be managed.

The run-time tool 26′ controls and monitors the data servers 32′, 32″, 32′″ through communications with the client network management application 27′. The client network management application 27′ passes communications from the run-time tool 26′ to the appropriate server network management application 34. The client network management application 27′ also passes communications from the server network management applications 34′, 34″, 34′″ to the run-time tool 26′.

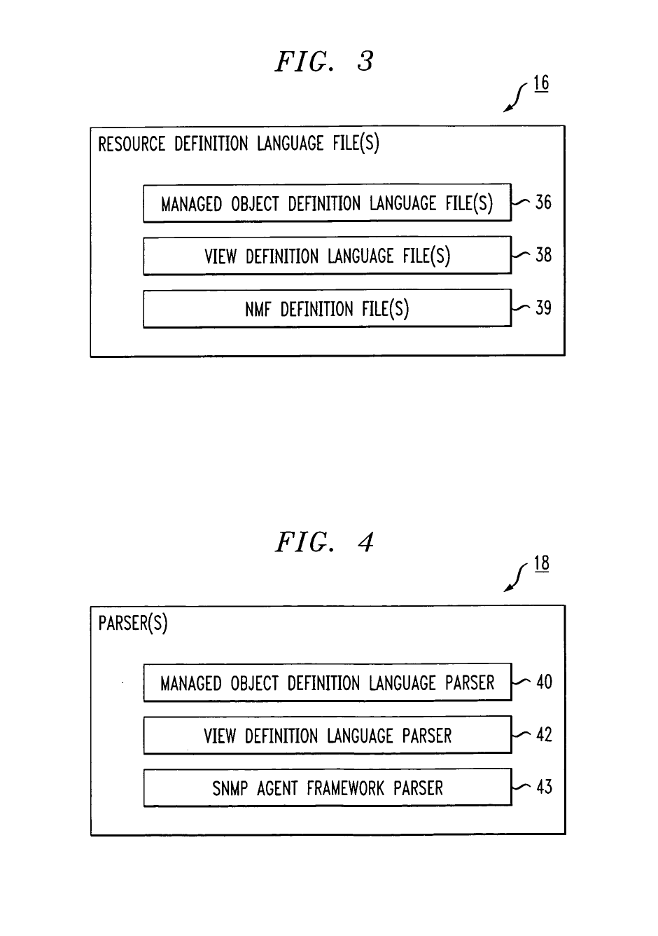

With reference to FIG. 3, an embodiment of the resource definition language file(s) block 16 includes managed object definition language (MODL) file(s) 36, view definition language (VDL) file(s) 38, and network management forum (NMF) file(s) 39. The VDL file(s) 38 are optional. MODL is a language used to organize the managed resources. MODL allows for definition of managed resources as managed object classes. The MODL file(s) 36 include constructs to organize the data model of the network design into managed object classes. This facilitates readability and provides a mechanism for abstracting the managed resources in the network design. VDL is a specification language based on MODL that describes managed object views. Each VDL file 38 (i.e., managed object view) is a collection of managed attributes that are scattered across various managed objects. The VDL file(s) 38 are entities that are essentially wrappers for corresponding managed objects included in the respective managed object views. The NMF file(s) 39 acts as an input for generating the classes required to access the managed objects and their attributes. The NMF file(s) 39 supply mapping information between MIB tables and managed object classes.

With reference to FIG. 4, an embodiment of the parser(s) block 18 includes an MODL parser 40, a VDL parser 42, and an SNMP agent framework (SAF) parser 43. The VDL parser 42 is optional. The MODL parser 40 receives the MODL file(s) 36 and builds an intermediate representation of the file contents that includes a parse tree and object meta-data. The parse tree and object meta-data is provided to the code generator(s) 23 for generation of MODL and database management code. The object meta-data is also provided to the VDL parser 42. The VDL parser 42 receives the VDL file(s) 38 and the object meta-data and builds view meta-data. The object meta-data and view meta-data are provided to the code generator(s) 23 for generation of VDL code. The SAF parser 43 receives MODL files created by the MIB converter and the NMF files and creates an output that is provided to the code generator(s) 23 for generation of SAF code.

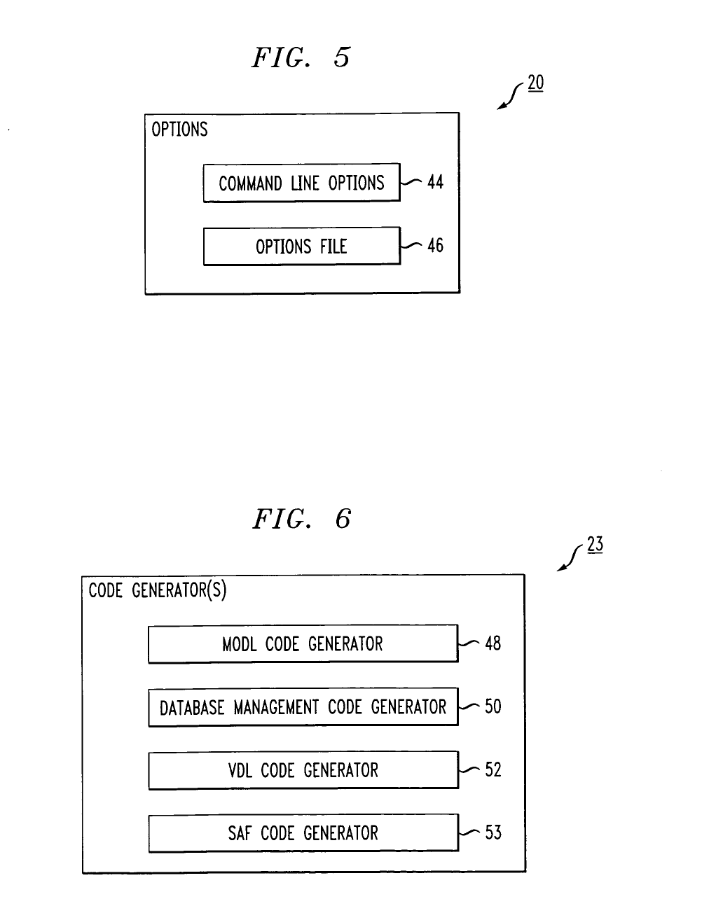

With reference to FIG. 5, an embodiment of the options block 20 includes command line options 44 and an options file 46. The options file 46 is optional. The command line options 44 include arguments and parameters to commands to initiate code generation. Various combinations of arguments and parameters are optional and permit developers to customize code generation to the current stage of application development and their current needs. The options file 46 is a sequence of commands in a file that similarly permit developers to customize code generation. The options file 46, for example, can specify reuse of code that was generated previously so that current code generation may be limited to areas that have changed.

With reference to FIG. 6, an embodiment of the code generator(s) block 23 includes an MODL code generator 48, a database management code generator 50, a VDL code generator 52, and an SAF code generator 53. The MODL code generator 48 receives the parse tree from the MODL parser 40 and instructions from the option(s) block 20 for generation of MODL code. The MODL code generator 48 generates code for instantiating and accessing the managed resources and objects in the network design from the MODL file(s) 36. The database management code generator 50 receives object meta-data from the MODL parser 40 and instructions from the option(s) block 20 for generation of database management code. The database management code generator 50 generates database schema for transient and/or persistent managed objects and trigger definitions for database updates from the MODL file(s) 36. The VDL code generator 52 receives view meta-data from the VDL parser 42 and instructions from the option(s) block 20 for generation of VDL code. The VDL code generator 52 generates code for defining managed object views from the MODL file(s) 36 and VDL file(s) 38. The SAF code generator 53 generates code for providing an SNMP interface to managed object resources.

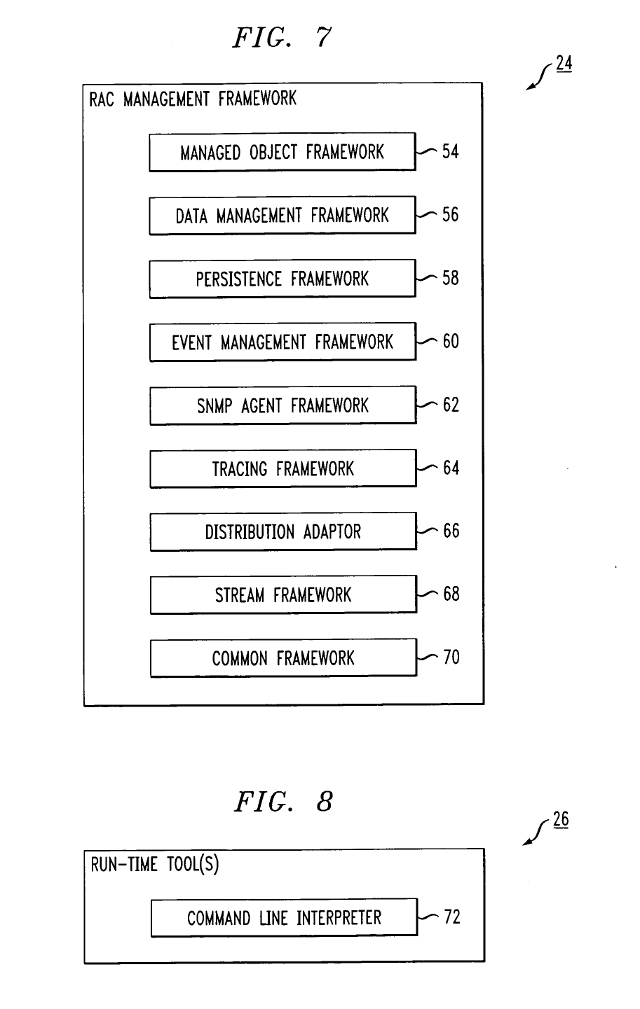

With reference to FIG. 7, an embodiment of the RAC management framework block 24 includes a managed object framework (MOF) 54, a data management framework (DMF) 56, a persistence framework (PF) 58, an event management framework (EMF) 60, an SNMP agent framework (SAF) 62, a tracing framework 64, a distribution adaptor (DA) 66, a stream framework 68, and a common framework 70. MOF 54 includes a set of classes that work in close cooperation to provide the management functionality of the network management applications. The MOF 54 is the core framework and provides object representations and interfaces for network management applications.

DMF 56 is used to make certain managed objects persistent and makes these persistent managed objects accessible to network management stations (NMSs). The DMF 56 also maintains consistency of the persistent data and permits various servers within the network design to share the data, for example, in real-time. PF 58 provides a portable persistent database interface to network management applications. This permits MODL and other coding for the applications to be developed transparent of any underlying database implementation.

EMF 60 includes a centralized event management server that performs event management routing and broadcasting. The EMF 60 unifies various system event generations and handling schemes into one uniform event processing model. SAF 62 provides network management applications with a gateway between MOF and SNMP protocols. SAF 62 acts as a proxy for SNMP protocol. SAF 62 also provides an interface definition language (IDL) interface through which other system elements can communicate using CORBA.

The tracing framework 64 provides network management applications with an option to emit tracing information that can be saved to a log file for subsequent problem analysis. The tracing framework 64 provides developers and users with multiple tracing levels. DA 66 is an adaptation layer framework for transparent distributed programming. DA 66 provides a pattern for utilizing client and server object proxies to allow code for distributed applications to be written without having to explicitly deal with distribution issues.

The stream framework 68 supports the encoding of objects into a stream and the complementary reconstruction of objects from the stream. The stream framework 68 permits objects to be passed by value from the client to the server through various communication mechanisms. The common framework 70 includes a set of utility classes that are used across the RAC management framework 24. The common framework 70 reduces redundancy across the RAC management framework 24, thereby reducing code for network management applications.

With reference to FIG. 8, an embodiment of the run-time tool(s) block 26 includes a command line interpreter 72. The command line interpreter 72 is a utility for monitoring and controlling managed objects associated with a network management application. The command line interpreter 72 includes interactive and batch modes of operation.

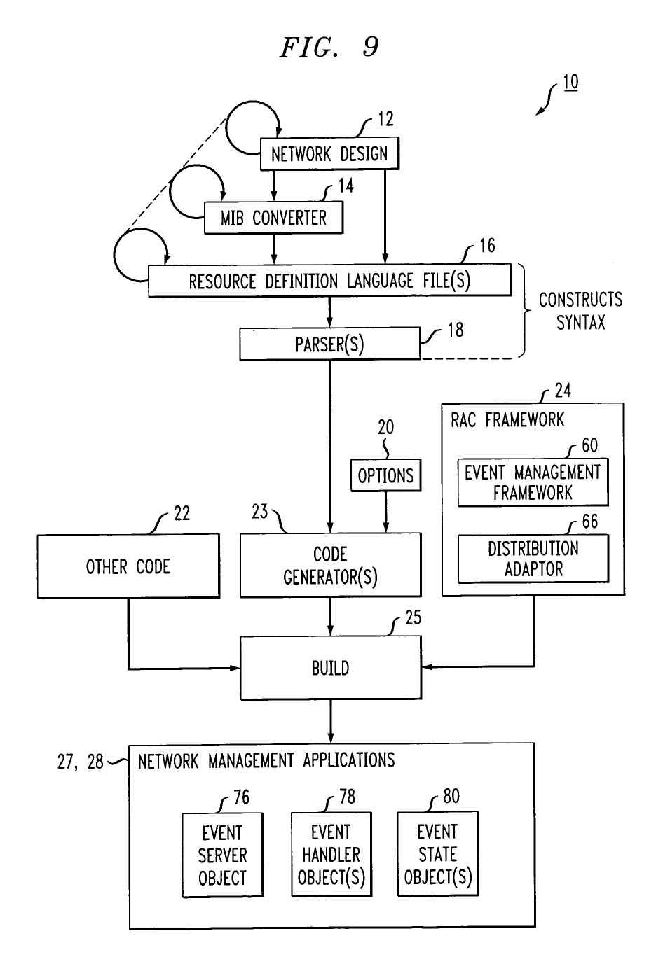

With reference to FIG. 9, the RAC development environment 10 shows that the build process 25 uses the EMF 60 and DA 66 to provide an event server object 76, one or more event handler objects 78, and one or more event state objects 80 within the network management applications 27, 28. The EMF 60 is a model that is platform independent, reusable, dynamic, distributed and scalable. The network management applications 27, 28 generated using the RAC development environment 10 uses the EMF 60 to accept, run, monitor, and terminate events. EMF 60 provides the event server object 76, one or more event handler objects 78, and one or more event state objects 80 for the network management applications 27, 28.

The event server object 76 is the engine of the EMF 60. It is responsible for routing and distributing events to appropriate event handler objects 78. The event handler object 78 performs event processing. Information associated with an event is encapsulated within the event state object 80. The event state objects 80 are mobile. For example, an event state object 80 may act as an agent that travels between various data servers 32 to provide and gather information from various event handler objects 78. The event state object 80 is created dynamically when an event occurs and destroyed when the corresponding event processing is completed. A given event can be processed by a single event handler object 78 or multiple event handler objects 78. The event handler objects 78 are not bound together at compile time (i.e., build process). Rather, the event handler objects 78 are connected together at runtime by the event server object 76. This late component binding scheme provides more flexibility for the network management applications 27, 28 to adapt to network (or system) conditions at runtime and changes in the network (or system) design 12.

The EMF 60 uses the late binding scheme to connect events and handlers. The event server object 76 acts as a messenger that delivers an event that is encapsulated in an event state object 80 to one or more event handler objects 78. Developers can build event handler objects 78 to monitor and service any event. The event server object 76 allows an event handler object 78 to monitor multiple events or multiple event handler objects 78 to monitor a single event. To accomplish this, developers build event handler objects 78 and register them with the event server object. Since the event handler object 78 is both platform and distribution independent, developers can scatter or migrate event handler objects 78 throughout the network (or system). Platform and distribution transparency is achieved by building the EMF 60 on top of a DA layer. The EMF 60 utilizes proxies to achieve both platform and distribution transparency.

The event handler objects 78 can be registered with the event server object 76 either statically or dynamically. Static registration information is contained within a configuration .h file. The configuration .h file indicates where the event handler object 76 is located, which event or events each event handler object 78 is interested in monitoring, relationships with other event handler objects 78 that are also interested in the same event, and initial data required by an event handler factory. Dynamic event registration uses two event handler objects, e.g., register handler object and unregister handler object. The two event handler objects used for dynamic registration need to be registered statically in order to use dynamic registration. It is noted that dynamic registration is not fault tolerant.

The event state object 80 acts as an interface between other entities of the EMF. The event state object 80 begins with the client (or data server) that generated the event, gets dispatched to interested event handler objects 78 and is terminated by the event server object 76 after the last applicable event handler object 78 had been invoked. In order to support a wide array of events with various attributes, the event state object 80 allows simple data attributes to be added during runtime. Developers or users can attach key/value properties to any event state object 80 at run time without modification and access these properties later.

In summary, the EMF 60 provides a unified architecture and environment for defining and managing events across heterogeneous environments. This includes support for generic reporting of hardware, software, and application faults. The EMF 60 link multiple event handlers together to form a complete event handling process. Pre-build event handlers are available for reuse during development of subsequent network management applications using the RAC development environment 10. The EMF 60 supports both static and dynamic event notification registration. The EMF 60 can be applied to any network element and is available to multiple platforms (e.g., CORBA, TCP/IP, DCOM, etc.).

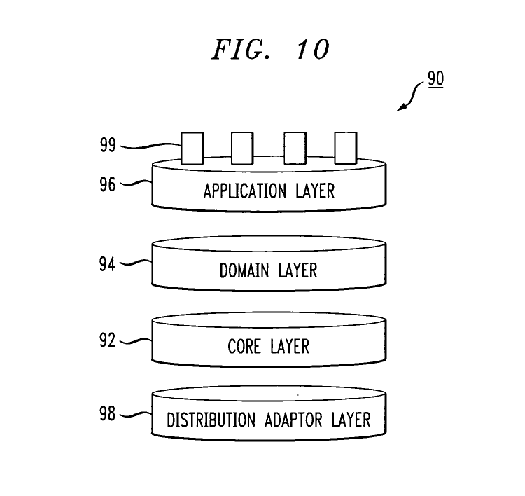

With reference to FIG. 10, the EMF uses a layered design 90 to maximize flexibility and reuse. Layered architecture is a style of organizing software according to levels of generality. This adds organization to developing the reusable components. The EMF includes a core layer 92, a domain layer 94, and an application layer 96. The diagram also shows a DA layer 98 that provides platform and distribution transparency for the EMF and variants of specific applications in a top layer 99.

The core layer 92 includes various abstract and base classes that define the EMF infrastructure and interface definitions. This includes the platform-independent EMF engine (i.e., event server object 76). This layer utilizes generic event API and makes no assumption about the types and parameters of events (e.g., trigger method of EMF). Some generic event handling objects 78 are also included of this layer (e.g., event source filtering class).

The domain layer 94 includes domain specific interface classes (i.e., API) and event processing reusable component classes (e.g., trigger alarm, trigger telecommunication management network (TMN), and trigger notify are all domain specific trigger methods provided by classes of this layer). This layer also includes event handling objects 78 that can be reused without modification because they are designed to be generic and reusable for a wide variety of event processing.

The application layer 96 includes component classes that developers can inherit from and use to create specialized components (i.e., customizable classes). This layer also includes pluggable objects that developers can reuse by simply providing the appropriate function pointers. Classes in this layer are more specialized than those of the other two layers.

With reference to FIGS. 9 and 10, the EMF 60 supports both serial and parallel event processing schemes. For serial processing, each event handler object 78 is invoked sequentially according to the order that it is registered. This is useful, for example, for event filtering and event processing collaboration.

An example of an event filtering scenario is where specialized reusable filtering event handler objects are added to the sequential event processing chain to perform filtering (e.g. event source filtering, leaky bucket filtering, etc.).

An example of an event processing collaboration scenario is where complex event processing requires services/data from some event handler objects 78 that are scattered throughout the network (or system). The event server object 76 can dispatch an event state object 80 to each of these event handler objects 78 sequentially. Each of these event handler objects 78 can extract processing information from the event state object 80 and update or add new information to the event state object 80 that is then be passed to the next event handler object 78.

Parallel event processing is useful when multiple independent processing is to be performed on a particular event.

The EMF 60 encourages reuse. The loosely coupled and standardized API event processing scheme encourages developers to reuse existing event handler objects 78 by simply chaining to them. When there is a large pool of reusable event handler objects available, developers can create event handling functions by connecting various event handler objects 78. The behavior of event processing is then determined by how these event handler objects 78 are interconnected. The well-defined APIs for the EMF 60 also simplifies the developer's task to create reusable modules.

The EMF 60 may include a graphical user interface (GUI) tool associated with the event server object 76 that helps with runtime debugging. This event server user interface (ESUI) is a runtime tool that can perform event trigger, event trace, and event analysis. Developers or users can specify event attributes for the either the trigger or trace operation using the ESUI controls. Another useful feature is that all operations can be logged into a script file. The script file can be played back to perform simulation, repetitive testing, or debugging tasks. Trace results can be specified to be displayed on any one of three display windows associated with the ESUI. Trace results may also be logged to a database. A trace analysis dialog associated with the ESUI allows developers or users to retrieve and analyze trace data in the database using SQL commands.

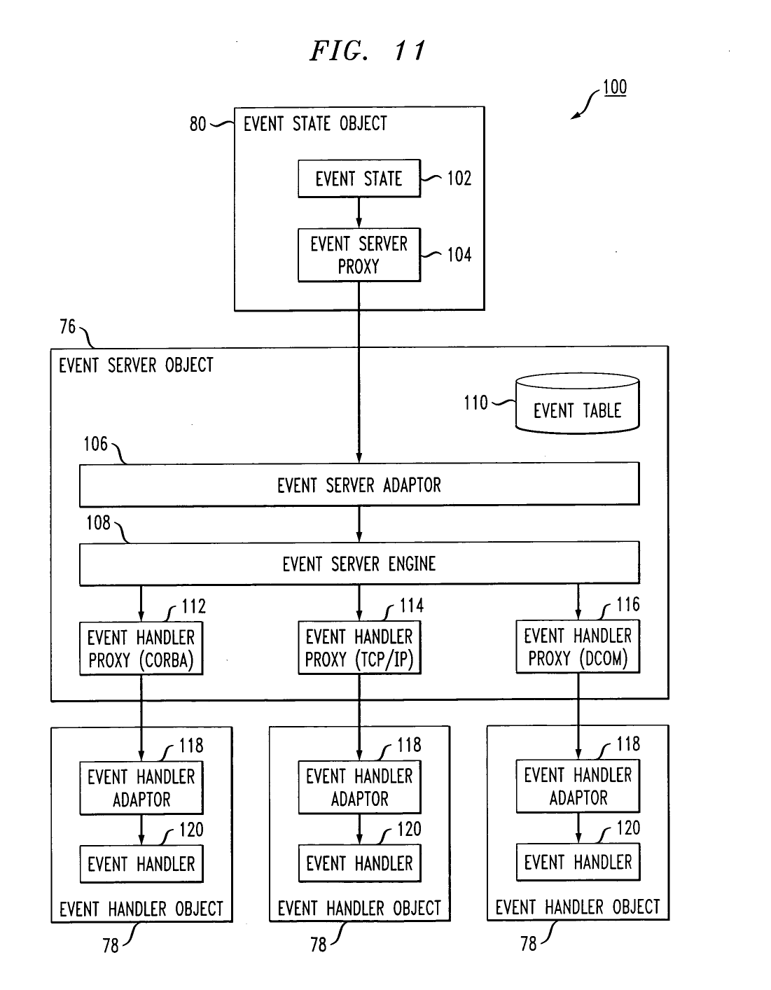

With reference to FIG. 11, the EMF architecture 100 shows that actual communication details (e.g., CORBA, TCP/IP, DCOM, etc.) between the event state object 80, event server object 76, and event handler objects 78 are provided by proxies and adaptors. The event state object 80 includes an event state 102 and an event server proxy 104. The event server object 76 includes an event server adaptor 104, an event server engine 108, an event table 110, an event handler proxy (CORBA) 112, an event handler proxy (TCP/IP) 114, and an event handler proxy (DCOM) 116. Each of three event handler objects 78 include an event handler adaptor 118 and an event handler 120.

The event state 102 provides alarm triggering for an event trigger. The event server proxy 104 and event server adaptor 106 provide communications between the event state 102 and the event server engine 108. The event server engine 108 provides a dynamically configurable table-driven process control engine that is application independent. The event table 110 relates events detected by event state objects 80 to event handler objects 78 and defines sequences and priorities for processing of the events by the event server engine 108.

The event handler proxy (CORBA) 112 and a first event handler adaptor 118 provide communications between the event server engine 108 and a first event handler 120 via a CORBA interface. The first event handler 120 provides, for example, alarm reporting for the detected event. The event handler proxy (TCP/IP) 114 and a second event handler adaptor 118 provide communications between the event server engine 108 and a second event handler 120 via a TCP/IP interface. The second event handler 120 provides, for example, hardware diagnostics for the detected event. The event handler proxy (DCOM) 116 and a third event handler adaptor 118 provide communications between the event server engine 108 and a third event handler 120 via a DCOM interface. The third event handler 120 provides, for example, hardware recovery for the detected event.

With reference to FIG. 12, the event message flow for a trigger alarm (i.e., Event B) is shown in conjunction with the event state object 80, event server object 76, and several event handler objects 78. An event state (B) 132 detects the Event B trigger alarm and communicates a trigger alarm message to the event server object 76 via the event server proxy 104. The event server adaptor 106 receives the trigger alarm message and passes it on to the event server engine 108. The event server engine 108 processes the trigger alarm message and communicates event information to event handler (3) proxy 134, event handler (4) proxy 136, and event handler (5) proxy 138. The event handler (3) proxy 134 and event handler (4) proxy 136 communicate the event information to a first event handler object 78. The event handler (5) proxy 138 communicates the event information to a second event handler object 78. An event handler adaptor 118 in the first event handler object 78 receives the event information from the event handler (3) proxy 134 and event handler (4) proxy 136 and passes the appropriate event information to an event handler (3) 140 and an event handler (4) 142. An event handler adaptor 118 in the second event handler object 78 receives the event information from the event handler (5) proxy 138 and passes it to an event handler (5) 144.

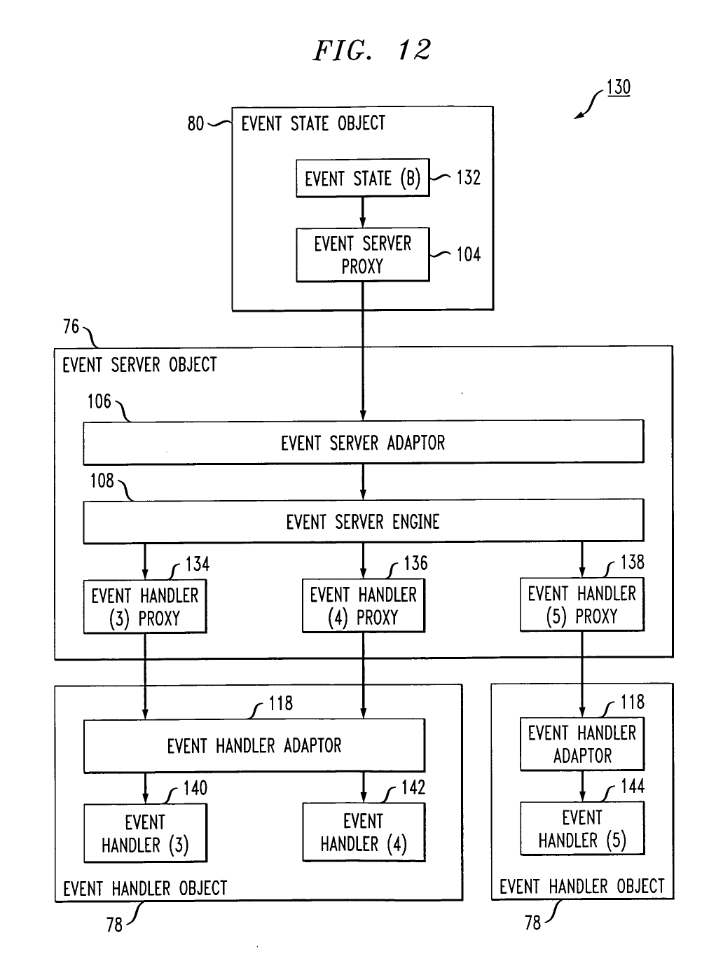

With reference to FIG. 13, the EMF 60 includes event server classes 146, event state classes 148, event handler classes 150, and global data 152. The event server classes 146 are used to build the event server object 76 (FIG. 9). The event state classes 148 are used to build the event state object(s) 80 (FIG. 9). The event handler classes 150 are used to build the event handler object(s) 78 (FIG. 9).

The global data 152 used for the EMF 60 is identified in the following table:

| Global Data | Comment |
|---|---|
| Class EventSrvrAbstract | Event server proxy object handle. |
| **anEventServer | Initialized by EMF and used by all to |
| | send message to event server. |
| Class EventHandlerAdaptor | Event handler adaptor object. Initialized by |
| *anEHP | EMF and used internally by EMF to |
| | receive message for all local event |
| | handlers from external processes. |
| Class EventStateFactory | Event state factory object for creating |
| *esFactory | and destroying various types of event |
| | state objects. |
| Struct ESDynamicAttr | Enum structure for all dynamic attribute |
| | definitions. (e.g., defined in |
| | DynamicEventAttr.h) |
| Struct ESevent | Enum structure for event groups, event |
| | types and event subtypes definitions. |
| | (e.g., defined in EventGroupTypes.h) |
| Enum ServerEnum | Enum definitions for all servers used by |
| | EMF. (Server with event triggering or |
| | processing functionality) |

The event server object 76 (FIG. 9) acts as a messenger that delivers an event that is encapsulated in an event state object 80 (FIG. 9) to one ore more event handler objects 78 (FIG. 9). The event server object 76 (FIG. 9) is the engine of the EMF 60. The event server object 76 (FIG. 9) is responsible for receiving incoming events, carried by an event state object 80 (FIG. 9), and routing them to the appropriate recipient event handler objects 78 (FIG. 9). The event table 110 (FIG. 11) within the event server object 76 (FIG. 11) is a configurable message routing table that controls the routing.

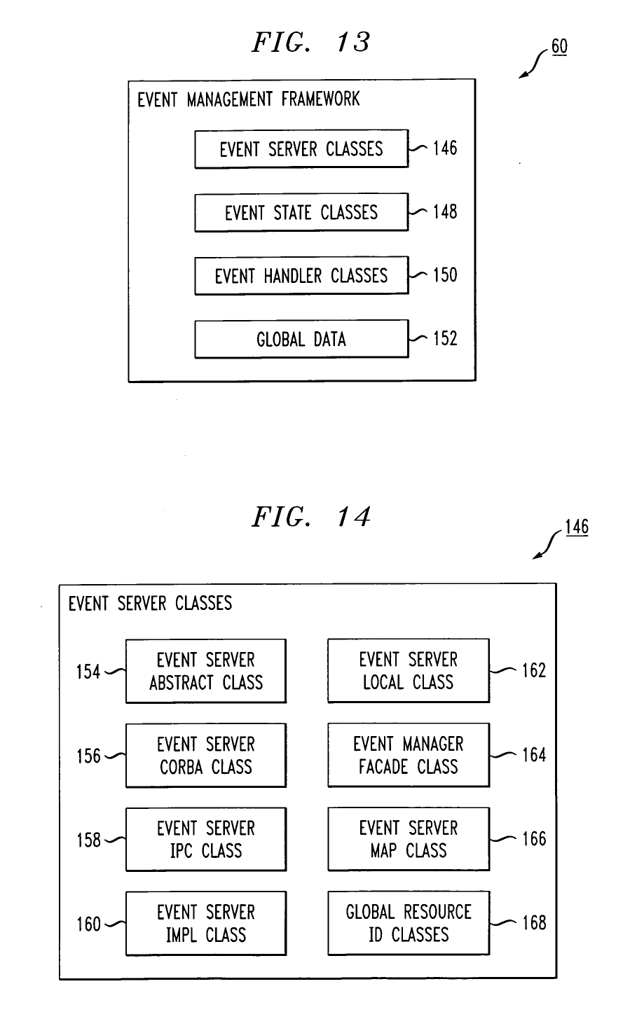

With reference to FIG. 14, the event server classes 146 include an event server abstract class 154, an event server CORBA class 156, an event server IPC class 158, an event server implementation class 160, an event server local class 162, an event manager facade class 164, an event server map class 166, and a global resource identifier (GRID) classes 168.

The event server abstract class 154 is a base event server class. The event server CORBA class 156 is a client side event server CORBA interface that uses an event server map IDL. The event server IPC class 158 is a client side event server IPC class that uses TCP/IP as the transport mechanism. The event server implementation class 160 is a server side event server implementation class. The event server local class 162 is an event server local class that is called internally by the event manager facade class 164. The event manager facade class 164 is a generic event server class that does the actual event processing. A developer can either use the event manager facade class 164 directly or inherit from it to implement a new event server class. The event server map class 166 is a virtual base class for getting the object reference of an event server map IDL and an event handler proxy map IDL.

As shown, the GRID classes 168 are a component of the event server class 146. The GRID classes 168 are an abstract representation of event source in a multi-format event sources system. For the event server class 146, the GRID classes 168 need to have a common way of interacting with various event source of different formats to perform comparison and filtering. The GRID classes 168 or event source are used to identify a resource in the EMF 60. One capability of the GRID classes 168 is the ability to perform a comparison with other GRID classes 168.

With reference to FIG. 15, the GRID classes 168 or event source are an abstraction that encapsulates the resource representation and provides a uniform interface for “event-source” processing. The hierarchy of the GRID classes 168 shows a GRID abstraction class 170, a moid GRID class 172, a resource ID GRID class 174, and an event GRID class 176. The GRID abstraction class 170 defines the interface. All resource types must define a corresponding GRID implementation class. For example, the moid GRID class 172 is a specialized class for a distinguished name. The resource ID GRID class 174 is a specialized class for a hardware resource. The event GRID class 176 is a specialized class for event source that is not represented by a distinguished name or a hardware resource.

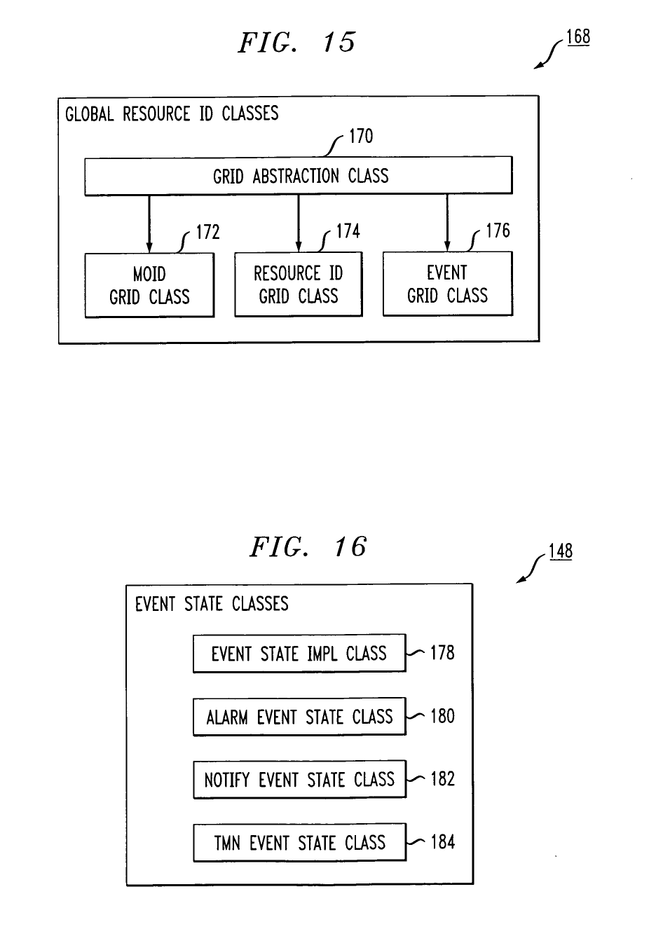

With reference to FIG. 16, the event state classes 148 include an event state implementation class 178, an alarm event state class 180, a notify event state class 182, and a TMN event state class 184. The event state classes 148 collect and dispatch event information. Information associated with an event is encapsulated within an event state by the event state classes 148. The event state travels between an event trigger client process, an event server process, and various event handler processes which may be distributed throughout the network or system. The event state implementation class 178 is a base event state class. The alarm event state class 180 encapsulates information associated with an alarm event. The notify event state class 182 encapsulates information associated with a notification event. The TMN event state class 184 encapsulates information associated with a TMN event.

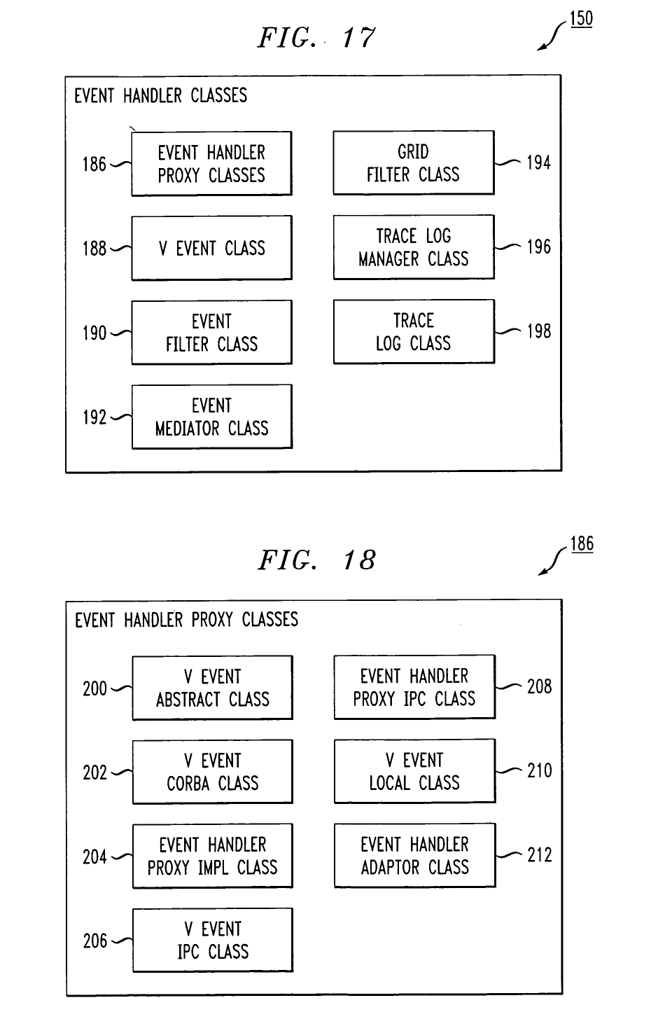

With reference to FIG. 17, the event handler classes 150 include an event handler proxy classes 186, a V event class 188, an event filter class 190, an event mediator class 192, a GRID filter class 194, a trace log manager class 196, and a trace log class 198. The event handler classes 150 provide an object oriented framework for developing event handlers. The primary goal of the library is to reduce the time required to develop robust and efficient event handlers. The event handler classes 150 are designed to present a consistent interface across a broad range of event processing. This typically reduces the learning curve for event handler programming.

The event handler proxy classes 186 act as an agents for event handlers. The static handler proxies are created and registered to the event server at the initialization time. The dynamic handler proxies are created and registered to the event server at the runtime. The V event class 188 is a base event handler class for performing event processing. Real event handlers may inherit from the V event class 188. The event filter class 190 is an alarm event filter in which developers can specify alarm type, alarm id, alarm severity, alarm probable cause, and event sources as filter criteria. Developers can specify up to a maximum of 10 different GRID event sources as part of the filter criteria. Wildcard values of zero can be used for any of the alarm filter parameters. The event filter class 190 returns VEvent_Abort when filtering fails and the event server then terminates the event processing chain.

The event mediator class 192 is an event handler iterator that invokes managed event handlers sequentially according to the order they are added. When this handler method is invoked, the event mediator class 192 invokes the handler method of managed event handlers and takes appropriate action based on their return code. The GRID filter class 194 is a generic GRID filter where developers can specify up to a maximum of 10 GRIDs as filter criteria. Developers can also specify an optional event subtype ID as filter criteria. The GRID filter class 194 returns VEvent_Abort when filtering fails and the event server then terminates the event processing chain.

The trace log manager class 196 is an event handler that works in conjunction with the trace log class 198 to provide a tracing capability for events managed by the event server. The trace log manager class 196 is designed to control a trace condition for the trace log class 198. The trace log manager class 196 can support multiple trace log handlers. Each trace log can be programmed to trace different events and have its trace result output to a different destination. The trace log manager class 196, for example, accepts trace and cleartrace commands. The trace log manager class 196 is an event handler of notify type. Commands are passed as notify text to the trace log manager class 196 with the following format:

[command:group:type:subtype:window:hostname]

For example, “command” is trace or cleartrace, “group” is an event group to trace or cleartrace, “type” is an event type to trace or cleartrace, “subtype” is an event subtype to trace or cleartrace, “window” is a window number of a trace display, and “hostname” is an ASCII name of a trace display host. The trace log class 198 is an event handler that listens to events received by event server and determines if trace is enabled for the event. If trace is enabled, a trace message including a serialized string of event state object is sent to a trace handler plug-in.

With reference to FIG. 18, the event handler proxy classes 186 include a V event abstract class 200, a V event CORBA class 202, an event handler proxy implementation class 204, a V event IPC class 206, an event handler proxy IPC class 208, a V event local class 210, and an event handler adaptor class 212. The V event abstract class 200 is a base event handler proxy class. The V event CORBA class 202 is a client event handler proxy class using event handler proxy map IDL. The event handler proxy implementation class 204 is a server implementation class of event handler proxy map IDL. The V event IPC class 206 is a client event handler proxy class using TCP/IP. The event handler proxy IPC class 208 is a server event handler proxy class implemented with TCP/IP. The V event local class 210 is an event handler proxy local implementation. The event handler adaptor class 212 is used internally by the EMF to receive messages for all local event handlers.

The following paragraphs describe an event scenario of EMF programming based on an exemplary problem. In this exemplary problem, there is a need to monitor an equipment alarm subtype hardware error Y from a certain hardware unit X using a leaky bucket analysis method and perform a recovery action when the analysis fails. This alarm type could also be generated by other hardware unit types. The leaky bucket analysis refers to the decrementing of nonzero error counters. This decrementing is done at set time intervals. When the counter is decremented it is checked to see if it exceeds a preset threshold. If the threshold is exceeded then recovery actions are taken.

Using an EMF-based solution, creating event processing programs involve the steps of: 1) outline processing program flow, 2) partition program flow and create event handlers (e.g., many event handlers can be reused or inherited from the reusable handler library), and 3) chain the event handlers together as outlined in the program flow.

The processing program flow outline includes: 1) determining if the alarm is generated from the correct hardware unit, 2) if it is from the correct hardware unit, performing the leaky bucket analysis, and 3) finally, performing recovery action if the leaky bucket analysis fails.

Next, the event handlers are created. The event handler GRID filter can be used from RAC library. FA leaky bucket and recovery action handlers can be inherited from the V event class.

In the final step, the event handlers are chained together in the following sequence: 1) GRID filter, 2) FA leaky bucket, and 3) hardware specific recovery action event handler.

The developer assigns event category-type-subtype values to each event sent to the EMF. For this particular exemplary problem, the following enumerated values are assigned: 1) category—alarm, 2) type—equipment, and 3) subtype—hardware error Y.

The hardware specific recovery action event handler may be created by inheriting from V event class. The corresponding HandlerFactory function that is responsible for creating recovery event handler is created. In most cases, the developer only needs to override handler method of V event class.

EventHandlers can be registered either statically or dynamically. To register statically, the developer updates the event structure configuration file. The configuration file contains the following information: 1) event handler IDs, 2) data to be used by event handler factories, 3) event handler location and its corresponding factory and data, and 4) relationships between events and event handlers. For this exemplary problem, GRID filter, FA leaky bucket, and recovery handlers to alarm category (e.g., equipment EventType and hardwareError_Y EventSubtype) are registered.

To generate an event, the developer can use either a generic event trigger method as shown below:

(*anEventServer)->Trigger(anEventState);

or an event category specific method as shown below:

(*anEventServer)->TriggerAlarm(equipment,
hardwareError_X, severity, probableCause, “Alarm Text”,
“Debug Text”, eventSource);.

When the event server receives an event of error alarm type Y, it first invokes the GRID filter event handler to determine if it is generated from hardware unit type X. If it is not from hardware unit type X, GRID filter returns an abort code so that event processing for this chain is terminated. Otherwise, the event server invokes FA leaky bucket event handler to increment the error count and check to see if it exceeds a preset threshold. Finally, recovery handler is invoked only if event alarm type Y is from hardware type X and the leaky bucket error count exceeds the threshold.

Continuing this exemplary scenario, the developer defines server enumeration in a enum ServerEnum of a ServerEnum.h header file. The server enumerations are used by the EMF to resolve the server at runtime. The developer also defines server names and corresponding ServerEnum values in a ServerNameType in a ServerNameTypes.C source file. For client servers that utilize the service of the EMF, the developer only needs to call one event server initialization function in the initialization routine to perform initialization. The EMF initialization routine performs all initialization steps locally and does not need to communicate with remote servers. The following code describes the initialization function API:

```
long EMFLocalStartup (
  long eventServerInterfaceType,
  char *localServerName,
  long localServerInstance,
  char *eventServerName,
  long eventServerInstance,
  struct ServerNameTypeStruc *serverNameType,
  struct EventTableStruc *eventRegistrationTable,
  struct VEventStruc *eventHandlerDefTable,
  long eventServerType=EMF::Distributed
);
```

| Parameter | Comment |
|---|---|
| eventServerInterfaceType | Determines interface type required to communicate with |
| | event server. Use enum defined in ESInterface structure in |
| | ESFunctions.h file. |
| localServerName | ASCII name of local server defined in ServerNameType structure |
| | in ServerNameType.C file. |
| localServerInstance | Numeric value indicating the instance of the local server. |
| eventServerName | ASCII name of event server defined in ServerNameType |
| | structure in ServerNameType.C file. |
| eventServerInstance | Numeric value indicating the instance value of event server. |
| serverNameType | Pointer to ServerNameTypeStruc C data structure that |
| | defines all servers/processes that utilizes the services of |
| | EMF. |
| eventRegistrationTable | Pointer to EventTableStruc C data structure that defines the |
| | registration configuration of all event handlers. |
| eventHandlerDefTable | Pointer to VEventStruc C data structure that defines |
| | properties of event handlers. |
| eventServerType | Configure Event Server as either EMF::Centralized, |
| | EMF::Distributed. |

Events are defined in a structure called Esevent in EventGroupTypes.h except for events that are defined externally by other subsystems (e.g. alarm and TMN state change event types are defined in a header file generated by SNMP MIB compiler). Event type and subtype enumeration names are named in a self defined way to allow for automated parsing by another program (e.g. event server user interface program uses this organization to extract event group, type, subtype information to populate appropriate list boxes). The following describes the naming representation scheme: 1) enum name consists of concatenated string of keyword/value pair(s), 2) underscore( ) is used as separator, 3) all keywords are in upper case, 4) keyword/value pairs are concatenated in the order based on the event structure organization (group-type-subtype), the last entry is identified by a keyword without a value, and 5) there are three keywords in event structure: GROUP, TYPE and SUBTYPE.

Using the above guideline, adding a BTSAwaitingConfig notify event type with corresponding Begin and Completed subtypes includes: 1) adding BTSAwaitingConfig to enum GROUP_Notify_TYPE and 2) creating enum GROUP_Notify_TYPE_BTSAwaitingConfig_SUBTYPE with entries of Begin and Completed. An example of this is shown below:

```
  Struct Esevent {
    ...
  enum GROUP_Notify_TYPE {
    ...
    BTSAwaitingConfig
  };
  enum GROUP_Notify_TYPE_BTSAwaitingConfig_SUBTYPE
{
    Begin,
    Completed
  };
};
```

The developer creates a specialized event handler class by inheriting from V event class. The developer may also create the corresponding event handler create factory function. The factory function has the following API:

Class VEvent* [eventhandler]Factory(void *factoryData);

[eventhandler] is the name of the event handler class. It is recommended that the factory function be placed in the same source file as the event handler class. During initialization, the corresponding event handler create function will be called to return an instance of event handler object. It is therefore possible to create a 1:1 or n:1 relationship between events and event handlers by programming the behavior of event handler factory. To create an event handler object that handles multiple events, the developer creates one event handler object in the even handler factory and has it return the same object instance every time it is called. For an event handler class that is designed to be able to handle multiple events when it is intended to have a one instance per event relationship, the developer creates a new event handler object each time the event handler factory is called.

To provide more programmable flexibility to the event handler factory, the developer can pass initialization data related to the event handler creation through the formal parameter void *factoryData. For an event handler that had been registered with event server statically, initialization data can be specified in the same registration configuration file.

For most event handlers, the developer overrides the constructor and handler method. The handler method is invoked by the event server when an event that is registered by event handler is triggered. The handler method has the follow API:

Long [eventhandler]::Handler(EventState *anEventState);

This has one formal parameter, class EventState *anEventState. EventState object contains information related to the triggered event. This includes, for example, event type, event source, static event attributes and dynamic event attributes.

The event handler can terminate an event handling chain by returning VEvent_Abort, otherwise the event handler returns VEvent_OK. This gives the event handler the capability to control the event processing condition. To maximize reusability, it is recommended that event handler be designed using the following guidelines: 1) do not overload an event handler with too much functionality, try to break it up into multiple handlers and chain them together instead, 2) use abstraction, where appropriate, when the event handler is interfacing with external objects or functions, 3) search existing event handler classes to determine if they can be reused without modification or with simple modification before developing a new handler, and 4) minimize platform, operating system, and middleware dependency.

Event handlers can be registered either statically or dynamically. To register statically, the developer modifies a static registration configuration file EventStrucDef.h. The developer can use a Visual Builder tool to assist in event registration modification. The EventStrucDef.h configuration file is divided into five sections. Each section is enclosed by a unique section begin name and section end name. These section names are used by Visual Builder program to interpret and update the configuration file.

For example, the structure and organization of the configuration file may include the following sections: 1) EVENT_HANDLER_ID, 2) EVENT_FACTORY_DEF, 3) EVENT_FACTORY_DAT_STRUCT, 4) EVENT_STRUCT, and 5) EVENT_TABLE_STRUCT.

The EVENT_HANDLER_ID section includes a #define for event handler IDs. The value of each event handler ID is unique. The event handler ID provides a link between entries of VEventStruc and EventTableStruc structures. The event handler ID is also used internally as a handler object identifier during event dispatching. Each handler instance has a unique ID. The IDs for each handler instance have a one to one relationship with a corresponding event handler object instance.

The EVENT_FACTORY_DEF section includes event handler factory prototypes. These prototypes are used in the EVENT_STRUCT section. The event server invokes the appropriate event handler factory during initialization based on information in the EVENT_TABLE_STRUCT and EVENT_STRUCT sections. Each server or process is given a unique server #define. A NULL event handler factory #define is defined for servers for which an event handler factory does not exist. For example, if DataChangeEventHandlerFactory only exists in a hardware server, the corresponding event handler factory is defined as follows:

#ifdef HARDWARESERVER
class VEvent *DataChangeEventHandlerFactory(void
*factoryData);
#else
#define DataChangeEventHandlerFactory 0
#endif

The EVENT_FACTORY_DAT_STRUCT section includes data structures used by event handler factories. The data structures used by an event handler factory are enclosed with a substructure called EVENT_FACTORY_DATA_GROUP. When the event server invokes an event handler factory, it passes the corresponding data structure pointer to the event handler factory as void * formal parameter.

The EVENT_STRUCT section defines the properties of event handlers. Each event handler is defined by the ID defined in the corresponding EVENT_HANDLER_ID section, the create factory defined in the corresponding EVENT_FACTORY_DEF section, the factory data structure defined in the corresponding EVENT_FACTORY_DATA_STRUCT section, a corresponding ASCII server name, and the corresponding server instance ID.

The EVENT_TABLE_STRUCT section defines the relationship between events and event handlers. An event is defined by group, type, and subtype. There is also an extra event chain ID condition that the developer can specify. The event chain ID allows event handlers to be arranged into multiple sequences. This is useful for situations where the developer wants to process the same event using different filtering criteria.

The GRID class includes three types of GRID subclasses: MoidGRID, ResourceldGRID, and EventGRID. Each of these subclasses encapsulates a unique event source representation. The constructor syntax for these subclasses is shown below:

// Constructor for MoidGRID class
MoidGRID(class DistinguishedName *dn);
// Constructor for ResourceIdGRID class
ResourceIdGRID(unsigned long resourceID, unsigned long
btsID);
// Constructor for EventGRID class
EventGRID(long gridclass, long grin0, long grin1, long
grin2=0, long grin3=0, long grin4=0, long grin5=0, long
grin6=0, long grin7=0, long grin8=0);

Information associated with an event is encapsulated within a corresponding event state object which is created at the time when the event is triggered. An event group type specific event state subclass is assigned for each event group. The event state object is created dynamically by either a trigger client or the EMF when the event occurs and then destroyed by the EMF when the corresponding event processing is completed. The event state object is created only a global factory object esFactory. APIs that are provided for creating various event state objects are identified below:

// Create AlarmEventState object
AlarmEventState *Get(AlarmType alarmType, long alarmId,
AlarmSeverityType severity, ProbableCauseType
probableCause, char *alarmText, char *debugText, const
class GRID *esource);
// Create TMNEventState object
TMNEventState *Get(long stateType, long state, GRID
*esource);
// Create NotifyEventState object
NotifyEventState *Get(long notificationType, long
notificationId, const char *notificationText, GRID
*esource);

An exemplary API for creating a notify event state object is provided below:

// Create a NotifyEventState object
EventState *anES = esFactory->Get(Esevent::GPSTimeSrvrUP,
0, “GPS TimeServer UP”, new EventGRID(ProcessClass,
NE_BTS, 1, CP_SERVER, 1));

Steps for Adding Dynamic Attributes

Adding a dynamic attribute to an event state object provides a flexible and convenient way for a trigger client and event handlers to pass various primitive data parameters back and forth. The dynamic attributes can be added and specified at run time for dynamic attribute control. The following methods of event state class are related to dynamic attribute control: 1) to specify the number of attributes to add:

Long EventState::AddAttributeCount(long count);

2) to add the attribute and specify a value of character string data type:

Long EventState::AppendAttribute(long attributeType, char
*attributeName, char *attributeValuePointer);

3) to add the attribute and specify a value of long data type:

Long EventState::AppendAttribute(long attributeType, char
*attributeName, long attributeValue);

4) to add the attribute and specify a value of double data type:

Long EventState::AppendAttribute(long attributeType, char
*attributeName, double attributeValue);

5) to retrieve a character string data type attribute value:

Long EventState::GetAttribute(long attributeType, char
*attributeValue, long *size);

6) to retrieve a long data type attribute value:

Long EventState::GetAttribute(long attributeType, long
*attributeValue);

7) to retrieve a double data type attribute value:

Long EventState::GetAttribute(long attributeType, double
*attributeValue);

The following exemplary code demonstrates how a trigger client can attach attributes to an event state object before generating a trigger to the event server:

// Create an EventState object first
EventState *anES = esFactory->Get(Esevent::GPSTimeSrvrUP,
0, “any text”, new EventGRID(ProcessClass, NE_BTS, 1,
EVENT_SERVER, 1));
// Specify how many attributes to be added
anES ->AddAttributeCount(3);
// Set first attribute with value
anES ->AppendAttribute(EseventAttr::IPAddress, “GPS Srvr
IPAddr”, BTS);
// Set second attribute with value
anES ->AppendAttribute(EseventAttr::Port, “GPS Srvr
Port”, UDP_EVENT_PORT);
// Set third attribute with value
anES ->AppendAttribute(EseventAttr::BtsId, “BtsId”,
MCCbtsId);
// Generate Trigger using anES
(*anEventServer)->Trigger(anES);

The following exemplary code demonstrates how an event handler can retrieve attribute data from the event state object via a handler method:

char ipAddr[50];
long port, btsId;
size = 45;
anES->GetAttribute(EseventAttr::IPAddress, ipAddr,
&size);
anES->GetAttribute(EseventAttr::Port, &port);
anES->GetAttribute(EseventAttr::BtsId, &btsId);

Events can be generated using either a generic trigger event API or an event group specific trigger event API. An example of a generic trigger event API is provided below:

Long Trigger(EventState *anEventState);

This API allows a developer or user to generate any alarm group type. It also allows the developer or user to append dynamic attributes to the event state object before the trigger.

Several examples of event group type specific trigger event APIs are provided below:

// Trigger alarm event
long TriggerAlarm(AlarmType alarmType, long alarmId,
AlarmSeverityType severity, ProbableCauseType
probableCause, GRID *esource);
// Trigger TMN state change event
long TriggerTMNEventState(long stateType, long state,
GRID *esource);
// Trigger notify event
long TriggerNotify(long notificationType, long
notificationId, const char *notificationText, GRID
*esource);

The EMF can be adapted to different platforms. For instance, developers can create platform specific proxies by creating platform specific DA based client proxies such as a V event [platform specific] class or an event server [platform specific] class. The V event [platform specific] class, for example, is the platform specific client proxy class for the “V event” event handler class. The V event [platform specific] class is inherited from the V event abstract class. The event server [platform specific] class is the platform specific client proxy class for the event manager facade class. The event server [platform specific] class is inherited from the event server abstract class.

The EMF library may provide proxies for both CORBA and TCP/IP platforms. For example, proxies for the CORBA platform are called EventSrvrCORBA and VEventCORBA. Similarly, proxies for the TCP/IP platform are called EventSrvrIPC and VEventIPC.

The developer also rewrites a GetESProxyHandle function with a platform specific version. The purpose of this function is to perform runtime binding to the remote server and return the handle to the remote EventHandlerProxy object. The array CreateVEvent[ ] is used by the EMF to create the appropriate remote VEvent proxy objects. The EMF library may provide factory functions, such as VEFactoryCORBA( ) and VEventIPC( ). During initialization, the developer or user initializes the CreateVEvent[ ] array with the necessary factory function for the specific platform being utilized. For example, the following code can be included in the initialization routine if the application runs on both CORBA and IPC platforms:

CreateVEvent[ESInterface::TCP_IP] = VEFactoryIPC;
CreaetVEvent[ESInterface::CORBA] = VEFactoryCORBA;

The EMF is initialized by a call to an EMFLocalStartup( ) function to tell the EMF the platform type, event server proxy factory function, local server name, local server instance, EMF server name, EMF server instance, and static registration data structure pointers.

Whenever the EMF detects a software error, it invokes a debug method from the base class TopObject. The debug method in turn calls the DebugHandling function to perform debug handling. Developers can modify or rewrite this function to adapt to a different error processing scheme.

One function that is commonly performed by event handler is to filter incoming events based on various combinations of event group, event type, event subtype, and event source conditions. The event handler may also retrieve the appropriate data or object using the event state object as a key. Selector and SelectorDataFactory classes are used to perform these functions. The Selector class is a container of event state objects. The Selector class has a compare method called IsValidSelection where it can compare the given event state object with the collection of event state objects that it contains. The Selector class returns TRUE if a match is detected. The Selector class can also be used to retrieve the appropriate data or object that corresponds to the given event state object. The Selector class accomplishes this function by working together with the SelectorDataFactory object. The SelectorDataFactory class is responsible for managing data or objects needed by the Selector class. When a match is detected, the SelectorDataFactory class generates a unique index for that particular event state object. This index is passed to the SelectorDataFactory object to retrieve the appropriate piece of data or object. The SelectorDataFactory class can be subclassed to specialize data allocation schemes, data structure, or object types.

The EMF may be added to a data server process (i.e., server network management application on a given data server) and/or the data client process (i.e., client network management application on a given agent server). When the EMF is added to the data server process the network management applications for the network or system are configured so that the data server process act as an event server. The following paragraphs provide exemplary procedures and code for configuring a selected data server process as an event server and a data client process to periodically trigger two events (i.e., DataChange and Sleep). The DataChange and Sleep events are triggered after the MO (TH=1, Simple=1) is created. The data server has event handler called SleepEventHandler and the data client has an event handler called DataChangeEventHandler to handle the events. A centralized model is used for the event server configuration.

The steps to create an exemplary header file ServerNameType.h are provided below. This file contains the ServerEnum definition and the global structure ServerNameType[ ] that defines the processes that use the EMF services.

```
#ifndef SERVERNAMETYPE_H
#define SERVERNAMETYPE_H
#include “esf/EventStruc.h”
enum ServerEnum {
    EVENT_SERVER,
    EVENT_CLIENT
};
struct ServerNameTypeStruc ServerNameType[ ] = {
    {“DataServer”, EVENT_SERVER, “EVENTSERVER”,
ESInterface::Local},
    {“DataClient”, EVENT_CLIENT, “EVENTCLIENT”,
ESInterface::CORBA},
    {0, −1, 0}
};
#endif
```

The steps to create an exemplary header file EventGroupTypes.h are provided below. This file defines the event group, event type, event subtype enumerations.

```
#ifndef EVENTGROUPTYPES_H
#define EVENTGROUPTYPES_H
struct ESevent {
    enum GROUP {
        Alarm,
        TMN,
        Notify
    };
enum GROUP_Notify_TYPE {
        System=1,
        DataChangeNotify=11,
        Sleep
    };
};
#endif
```

The steps to create an exemplary header file EventStrucDef.h are provided below. This file defines the global Event and Event Table Structure used in this overall example.

```
#ifndef EVENTSTRUCDEF_H
#define EVENTSTRUCDEF_H
#include “EventGroupTypes.h”
#include “esf/EventStruc.h”
// EVENT_HANDLER_ID
#define DATACHGNOTIFYHDLR 10
#define SLEEPHANDLER 100
// EVENT_FACTORY_DEF
#ifdef DATACLIENT
class VEvent *DataChangeEventHandlerFactory(void
*factoryData);
#else
#define DataChangeEventHandlerFactory 0
#endif
#ifdef DATASERVER
class VEvent *SleepEventHandlerFactory(void
*factoryData);
#else
#define SleepEventHandlerFactory 0
#endif
unsigned int sleepTime = 10;
// EVENT_STRUCT
struct VEventStruc aVEventStruc[ ] = {
    {DATACHGNOTIFYHDLR, DataChangeEventHandlerFactory, 0,
        “DataClient”, 1},
    {SLEEPHANDLER, SleepEventHandlerFactory, (void
*)&sleepTime,
        “DataServer”, 0},
    {−1}
};
// EVENT_TABLE_STRUCT
struct EventTableStruc aEventTableStruc[ ] = {
    {ESevent::Notify, ESevent::DataChangeNotify, 0, 0,
        {DATACHGNOTIFYHDLR, −1, −1, −1, −1}},
    {ESevent::Notify, ESevent::Sleep, 0, 0,
        {SLEEPHANDLER, −1, −1, −1, −1}},
    {−1}
};
#endif
```

The steps to add the EMF to the data server main are provided below. Assuming the centralized model for the EMF is used, an EventSrvrMAP IDL implementation is created. The non event server process uses the EventSrvrMAP IDL interface to get the object reference of the implementation class to send out the trigger( ). The EMF initialization is done with the function call EMFLocalStartup( ).

```
...
#include “esf/EMFStartup.h”
#include “esf/EventSrvr_i.h”
...
// This define is used by EventStrucDef.h
#define DATASERVER 1
// Other headers
#include “EventStrucDef.h”
#include “ServerNameType.h”
...
    RUBY_TRY {
        // Create object reference of EventSrvrMAP IDL
implementation
        POA_EventSrvrMAP_tie< EventSrvr_i >* esServant =
            RUBY_CORBA_NEW POA_EventSrvrMAP_tie<
EventSrvr_i >(
            new EventSrvr_i( ) );
        // Register object reference of EventSrvrMAP with
POA
        if ( RubyPoaSpecific::registerObjRefWithPoa(
                esServant, serverNameId, “EventSrvrMAP” )
== 0 )
        {
            cerr << “Failed to register EventSrvrMAP obj
ref with POA” << endl;
            return −1;
        }
        // Init EMF, pass in the global structures
        EMFLocalStartup(ESInterface::Local,
            “DataServer”, 0, “DataServer”, 0,
            ServerNameType, aEventTableStruc,
aVEventStruc,
            EMF::Centralized);
        ...
    }
    ...
```

Alternatively, if the distributed model is used for the EMF, each EMF enabled process is event server, so there is no need to create the EventSrvrMAP IDL object reference. However, in the distributed model, each process installing event handlers creates an object reference of the EventProxyHandlerMAP IDL implementation. In this example, if the EMF is switched to use the distribute model, the EventHandlerProxyMAP IDL implementation for the data server is created instead of EventSrvrMAP IDL implementation.

The steps to add the EMF to the data client are provided below. This includes the code to build a new event handler called DataChangeEventHandler and register the event handler with the data client process. Steps to add the event trigger to the data client process are also provided.

The steps to create an exemplary header file File DataChangeEventHandler.h are provided below:

```
#ifndef DATACHANGEEVENTHANDLER_H
#define DATACHANGEEVENTHANDLER_H
#include “esf/VEvent.h”
class DataChangeEventHandler: public VEvent {
public:
    DataChangeEventHandler( );
    virtual long Handler(EventState *anES);
    virtual long GetClassString(char *);
};
#endif
```

The steps to create an exemplary C++ program file File DataChangeEventHandler.C are provided below:

```
#include “DataChangeEventHandler.h”
#include “util/FLXiostream.h”
#include “esf/MoidGRID.h”
#include “esf/NotifyEventState.h”
#include “mof/IntegerAttribute.h”
// This is an event handler that receives the data change
event notification through the event server.
DataChangeEventHandler::DataChangeEventHandler( )
{
}
long DataChangeEventHandler::Handler(EventState *anES)
{
    cout << “DataChangeEventHandler::Handler method
invoked”<< endl;
    GRID* grid;
    DistinguishedName* dn;
    anES->GetResource( &grid );
    MoidGRID* moidGrid = (MoidGRID*) grid;
    dn = moidGrid->getDN( );
    char data[1024];
    NotifyEventState* nes = (NotifyEventState*) anES;
    long len = 1023;
    nes->GetNotificationText(data, &len);
    cout << “class name = ” << data << endl;
    cout << “Dn = ” << dn->stringify( data, 1023) <<
endl;
    delete dn;
    return 0;
}
long DataChangeEventHandler::GetClassString(char
*className)
{
    strcpy(className, “DataChangeEventHandler”);
    return 0;
}
class VEvent *DataChangeEventHandlerFactory(void
*factoryData)
{
    return (class VEvent *)new DataChangeEventHandler( );
}
```

The steps to add code to an exemplary C++ program file File DataClient.C are provided below (only added code is shown):

```
...
#include “esf/EMFStartup.h”
#include “esf/EventHandlerProxyCORBA.h”
#include “esf/MoidGRID.h”
#include “esf/EventGRID.h”
#include “esf/EventStateFactory.h”
#include “esf/NotifyEventState.h”
#include “esf/EventSrvrAbstract.h”
...
// This define is used by EventStrucDef.h
#define DATACLIENT 1
...
#include “EventStrucDef.h”
#include “ServerNameType.h”
...
int
THTimeoutHandler::handle_timeout( const ACE_Time_Value&
value, const void* arg )
{
  ...
  // Create a NotifyEventState object of creating MO
event
  GRID *moidGrid = new MoidGRID(new
DistinguishedName(outdn));
  EventState* es = esFactory-
>Get(ESevent::DataChangeNotify,
      0, “MO created”, moidGrid);
  // Trigger the MO created event
  (*anEventServer)->Trigger(es);
  // Create a NotifyEventState object of sleep event
  GRID *eventGrid = new EventGRID( );
  EventState* es2 = esFactory->Get(ESevent::Sleep,
      0, “Sleep Event”, eventGrid);
  // Trigger the sleep event
  (*anEventServer)->Trigger(es2);
  ...
}
...
main( int argc, char** argv )
{
  ...
  RUBY_TRY
  {
      ...
      // Create object reference of
EventHandlerProxyMAP IDL
      // implementation
      POA_EventHandlerProxyMAP_tie< EventHandlerProxy
>* proxyIDL =
        RUBY_CORBA_NEW POA_EventHandlerProxyMAP_tie<
              EventHandlerProxy >(new
EventHandlerProxy( ) );
      // Register object reference with POA
      if( RubyPoaSpecific::registerObjRefWithPoa(
              proxyIDL, serverNameId,
“EventHandlerProxyMAP” ) == 0 )
      {
        cerr << “Failed to register
EventHandlerProxyMAP obj
              ref with POA” << endl;
        return −1;
      }
      // Init EMF
      EMFLocalStartup(ESInterface::CORBA,
        “DataClient”, 1, “DataServer”, 0,
        ServerNameType, aEventTableStruc,
aVEventStruc,
        EMF::Centralized);
      ...
  }
  ...
}
```

The above description merely provides a disclosure of particular embodiments of the invention and is not intended for the purposes of limiting the same thereto. As such, the invention is not limited to only the above-described embodiments. Rather, it is recognized that one skilled in the art could conceive alternate embodiments that fall within the scope of the invention.

1. A method of developing one or more application programs that cooperate to manage a distributed system comprising one or more servers, wherein at least one application program is associated with each server, the method including the steps:
a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system;
b) parsing the one or more resource definition language files to ensure conformity with the object-oriented resource definition language and creating an intermediate representation of the distributed system from the one or more conforming resource definition language files;
c) processing the intermediate representation of the distributed system to form one or more programming language classes, one or more database definition files, and one or more script files;
d) providing a reusable asset center framework to facilitate development of the one or more application programs, the reusable asset center including an event management framework that provides an event processing model for defining, routing, and processing events associated with the distributed system; and
e) building the one or more application programs from at least the one or more programming language classes, one or more database definition files, one or more script files, and the reusable asset framework.

2. The method as set forth in claim 1 wherein the distributed system is a network.

3. The method as set forth in claim 2 wherein the network is a telecommunication network.

4. The method as set forth in claim 1 wherein the event management framework includes event server classes, event state classes, event handler classes, and global data.

5. The method as set forth in claim 4 wherein the event server classes include an event server abstract class and at least one of an event server CORBA class, an event server IPC class, an event server implementation class, an event server local class, an event manager facade class, an event server map class, and a global resource identifier (GRID) classes.

6. The method as set forth in claim 5 wherein the GRID classes include a GRID abstraction class and at least one of a moid GRID class, a resource ID GRID class, and an event GRID class.

7. The method as set forth in claim 4 wherein the event state classes include an event state implementation class and at least one of an alarm event state class, a notify event state class, and a telecommunication management network event state class.

8. The method as set forth in claim 4 wherein the event handler classes include a V event class and at least one of event handler proxy classes, an event filter class, an event mediator class, a GRID filter class, a trace log manager class, and a trace log class.

9. The method as set forth in claim 8 wherein the event handler proxy classes include a V event abstract class, an event handler proxy implementation class, and at least one of a V event CORBA class, a V event IPC class, an event handler proxy IPC class, a V event local class, and an event handler adaptor class.

10. The method as set forth in claim 4 wherein the global data includes at least one of a Class EventSrvrAbstract, a Class EventHandlerAdaptor, a Class EventStateFactory, a Struct ESDynamicAttr, a Struct ESevent, and an Enum ServerEnum.

11. The method as set forth in claim 1 wherein the one or more application programs include a one or more event server objects, one or more event state objects, and one or more event handler objects associated with the event management framework.

12. The method as set forth in claim 1 wherein the event management framework supports both serial and parallel event processing schemes.

13. A method of developing one or more application programs in operative communication to manage a network including one or more servers, wherein at least one application program is associated with each server, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network created in the parsing step includes a parse tree;
c) processing the parse tree to form one or more programming language classes, wherein the one or more programming language classes formed include at least one of one or more system classes, one or more module classes, one or more managed object classes, and one or more composite attribute classes;
d) providing a reusable asset center framework to facilitate development of the one or more application programs, the reusable asset center including an event management framework that provides an event processing model for defining, routing, and processing events associated with selected managed objects of the network; and
e) building the one or more application programs from at least the one or more programming language classes and the reusable asset framework.

14. The method as set forth in claim 13 wherein the event management framework includes event server classes, event state classes, event handler classes, and global data.

15. The method as set forth in claim 13 wherein the one or more application programs include a one or more event server objects, one or more event state objects, and one or more event handler objects associated with the event management framework.

16. The method as set forth in claim 15 wherein the one or more application programs include one event server object configured in a centralized event management architecture.

17. The method as set forth in claim 15 wherein the one or more application programs include two or more event server objects configured in a distributed event management architecture.

18. The method as set forth in claim 15 wherein each event server object includes one or more event server adaptors, an event server engine, an event table, and at least one or an event handler proxy (CORBA), an event handler proxy (TCP/IP), and an event handler proxy (DCOM).

19. The method as set forth in claim 18 wherein the event table correlates event state objects with associated event handler objects and defines a processing sequence for the associated event handler objects.

20. The method as set forth in claim 15 wherein each event state object includes an event state implementation and an event server proxy.

21. The method as set forth in claim 15 wherein each event handler object includes an event handler adaptor and one or more event handler implementations.

22. The method as set forth in claim 15 wherein at least one event state object is created dynamically during runtime when a corresponding event occurs and destroyed when corresponding event processing is completed.

23. The method as set forth in claim 15 wherein at least one event handler object is connected to other components of the application programs at runtime via a late component binding scheme.

24. The method as set forth in claim 15 wherein at least one event handler object is statically registered with at least one event server using information contained in a configuration header file.

25. The method as set forth in claim 15 wherein at least one event handler object is dynamically registered and unregistered with at least one event server during runtime using a register handler object and an unregister handler object.

26. The method as set forth in claim 13 wherein the event management framework supports both serial and parallel event processing schemes.

27. A method of developing an application program to manage a network, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network includes object meta-data;
c) processing the object meta-data to form one or more programming language classes, one or more database definition files, and one or more script files, wherein the one or more programming language classes formed include at least one of an index class and a query class;
d) providing a reusable asset center framework to facilitate development of the application program, the reusable asset center including an event management framework that provides an event processing model for defining, routing, and processing events associated with the network; and
e) building the application program from at least the one or more programming language classes, one or more database definition files, one or more script files, and the reusable asset framework.

28. The method as set forth in claim 27 wherein the event management framework includes event server classes, event state classes, event handler classes, and global data.

29. The method as set forth in claim 27 wherein the one or more application programs include a one or more event server objects, one or more event state objects, and one or more event handler objects associated with the event management framework.

30. The method as set forth in claim 27 wherein the reusable asset framework is reusable with respect to development of another application program for another network.

31. The method as set forth in claim 30 wherein the event management framework is reusable with respect to development of another application program for another network.

32. The method as set forth in claim 27 wherein the event management framework includes a core layer, a domain layer, and an application layer in a layered architecture organized according to levels of generality where the core layer is the most general and the application layer is the least general.

33. The method as set forth in claim 27 wherein the event management framework supports both serial and parallel event processing schemes.
